(19) United States
(12) Patent Application Publication
(10) Pub. No.: US 2002/0055363 A1
(43) Pub. Date: May 9, 2002

(54) Cellular phone and method of operating cellular phone

(75) Inventor: Yoshiaki Tanaka, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/010,687

(22) Filed: Nov. 8, 2001

(30) Foreign Application Priority Data
Nov. 9, 2000 (JP) 2000-342393

(51) Int. Cl. H04Q 7/20

(52) U.S. Cl. 455/456; 455/421

(57) ABSTRACT

A cellular phone includes (a) a memory storing first data indicative of predetermined sites, and (b) a controller which receives second data from a base station which second data indicates where the cellular phone is, compares the thus received second data to the first data, and stops an operation of the cellular phone, if said cellular phone is located at the predetermined sites indicated by the first data.

### BACKGROUND OF THE INVENTION

1. Field Of The Invention

The invention relates to a cellular phone, and more particularly to a cellular phone which can be controlled not to be operated in predetermined sites such as a hospital.

2. Description Of The Related Art

Presently a lot of people use a cellular phone, and some persons often use a cellular phone in sites where a cellular phone should not be used. For instance, if someone receives a call in a cellular phone in a movie house, a theater or a concert hall, a bell informing a user of receipt of a call bothers persons around the user. In particular, if someone uses a cellular phone in a hospital, radio waves transmitted from the cellular phone might cause malfunction in medical appliances.

FIG. 1 is a block diagram of a structure of a conventional cellular phone. The cellular phone is comprised of an antenna 101 through which radio signals are transmitted therefrom and received from a network therethrough, a radio signal modem 103 which modulates radio signals to be transmitted and demodulates received radio signals, a memory 102 storing internal parameters and various data therein, a microphone/speaker 105, a switch 106 for turning the radio signal modem 103 on or off, a liquid crystal display unit 107A, a keyboard 107B, and a controller 104 controlling an operation of the above-mentioned elements 102, 103, 105, 106, 107A and 107B.

Conventionally, a user turned off a power supply to the cellular phone in a particular site where a cellular phone should not be used, such as a hospital, or turned the radio signal modem 103 off through the switch 106. By turning the radio signal modem 103 off through the switch 106, radio signals are no longer transmitted from the cellular phone, but the liquid crystal display unit 107A and the keyboard 107B are kept activated. Hence, a user could produce a mail or edit a telephone directory stored in the cellular phone, even if the radio signal modem 103 is turned off.

However, it is worrisome for a user to turn a cellular phone on or off each time he/she enters or leaves a site such as a hospital or a theater. As an alternative, a user may forget turn a cellular phone off, and enter a hospital or a theater with the cellular phone being on. In addition, though he/she turned the cellular phone off when he/she entered a hospital or a theater, a user may forget turn a cellular phone on when he/she leaves a hospital or a theater, resulting in that he/she might fail to receive an important or urgent call.

To solve such problems as mentioned above, Japanese Unexamined Patent Examination No. 2000-41282 has suggested a cellular phone system including a location informer and a cellular phone. The location informer is equipped at a site where a cellular phone should not be used. The location informer is comprised of a memory storing location data therein, a signal producer which produces a signal indicative location data, a signal transmitter which transmits the signal produced by the signal producer, a controller, and an antenna through which the signal is transmitted to a network. The cellular phone is comprised of an antenna through which the signal transmitted from the location informer is received, a receiver which receives the signal, a judgment unit which judges the signal, a memory, and a controller which controls an operation of the cellular phone in accordance with the received signal. On receipt of the signal from the location informer, the judgment unit of the cellular phone determines that the cellular phone is now at a site where a cellular phone should not be used, and then, the controller reads steps to be carried out, out of the memory, and stops power supply to the receiver.

Japanese Unexamined Patent Publication No. 2000-236572 has suggested a cellular phone system including a receiver and an informer both of which are equipped at a site in which a cellular phone should not be used, in a service area covered by a base station. A cellular phone transmits a signal to the receiver which signal indicates where the cellular phone is. If the signal shows that the cellular phone is at a site where a cellular phone should not be used, the informer 6 temporarily stops an operation of the cellular phone at the site, and announces a caller that the cellular phone is now at a site where a cellular phone should not be used. When the cellular phone leaves the site, the informer releases the cellular phone from being stopped in its operation.

In the above-mentioned Publications, the cellular phone systems have to include the location informer or the receiver and the informer in order to identify sites in which a cellular phone should not be used, resulting in a problem that the cellular phone systems are unavoidably complicated in structure and cannot avoid an increase in fabrication costs.

### SUMMARY OF THE INVENTION

In view of the above-mentioned problem in the conventional systems, it is an object of the present invention to provide a cellular phone and a method of operating the same both of which are capable of automatically stopping an operation of a cellular phone at a site in which a cellular phone should not be used, without any particular steps to be carried out by a user of the cellular phone.

In one aspect of the present invention, there is provided a cellular phone including (a) a memory storing first data indicative of predetermined sites, and (b) a controller which receives second data from a base station which second data indicates where the cellular phone is, compares the thus received second data to the first data, and stops an operation of the cellular phone, if the cellular phone is located at the predetermined sites indicated by the first data.

Herein, the predetermined sites may be sites in which it is unpreferable to make a call through a cellular phone, such as a hospital, a movie house, a theater or other public spaces.

The controller may download the first data into the memory from an external database.

The cellular phone may further include a modem which modulates signals to be transmitted from the cellular phone and demodulates signals received, in which case, the controller may stop an operation of the modem, if the cellular phone is located at the predetermined sites indicated by the first data.

There is further provided a cellular phone including a controller which receives from a base station both first data which indicates where the cellular phone is, and second data which indicates a first site within a service area covered by the base station, compares the thus received first data to the second data, and stops an operation of the cellular phone, if the cellular phone is located at the first site.

There is still further provided a cellular phone including (a) a memory storing first data indicative of a first area in which predetermined sites are, and (b) a controller which receives from a base station second data which indicates where the cellular phone is, compares the thus received second data to the first data, and stops an operation of the cellular phone, if the cellular phone is located in the first area.

There is yet further provided a cellular phone including a controller which receives from a base station both first data which indicates where the cellular phone is, and second data which indicates a first area within a service area covered by the base station, compares the thus received first data to the second data, and stops an operation of the cellular phone, if the cellular phone is located in the first area.

In another aspect of the present invention, there is provided a method of operating a cellular phone, including the steps of (a) storing first data indicative of predetermined sites, (b) receiving second data from a base station which second data indicates where the cellular phone is, (c) comparing the second data to the first data, and (d) stopping an operation of the cellular phone, if the cellular phone is located at the predetermined sites.

The method may further include the step of downloading the first data from an external database.

An operation of a modem of the cellular phone may be stopped in the step (d).

There is further provided a method of operating a cellular phone, including the steps of (a) receiving from a base station both first data which indicates where the cellular phone is, and second data which indicates a first site within a service area covered by a base station, (b) comparing the first data to the second data, and (c) stopping an operation of the cellular phone, if the cellular phone is located at the first site.

There is still further provided a method of operating a cellular phone, including the steps of (a) storing first data indicative of a first area in which predetermined sites are, (b) receiving from a base station second data which indicates where the cellular phone is, (c) comparing the second data to the first data, and (d) stopping an operation of the cellular phone, if the cellular phone is located in the first area.

There is yet further provided a method of operating a cellular phone, including the steps of (a) receiving from a base station both first data which indicates where the cellular phone is, and second data which indicates a first area within a service area covered by the base station, (b) comparing the first data to the second data, and (c) stopping an operation of the cellular phone, if the cellular phone is located in the first area.

The advantages obtained by the aforementioned present invention will be described hereinbelow.

In accordance with the present invention, a location at which a cellular phone is now is compared to a site or an area including the site in which a cellular phone should not be used, such as a hospital, a movie house, or a theater. If the cellular phone is at such a site or an area, the cellular phone is stopped its operation, or the modem of the cellular phone is stopped its operation. Accordingly, a user of the cellular phone is no longer necessary to turn the cellular phone off when he/she enters the above-mentioned site or area.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional cellular phone.

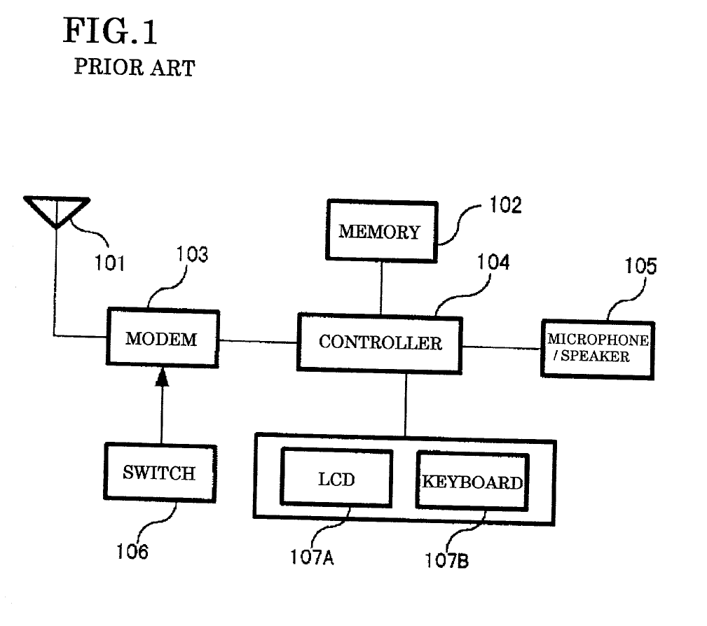

FIG. 2 is a block diagram of a cellular phone in accordance with the first embodiment.

FIG. 3 is a flow chart of steps to be carried out by the controller in accordance with the first embodiment.

FIG. 4 is a flow chart of steps to be carried out by the controller in accordance with the second embodiment.

FIG. 5 is a flow chart of steps to be carried out by the controller in accordance with the third embodiment.

FIG. 6 is a flow chart of steps to be carried out by the controller in accordance with the fourth embodiment.

### DESCRIPTION OF THE PREFERRED EMBODIMENTS

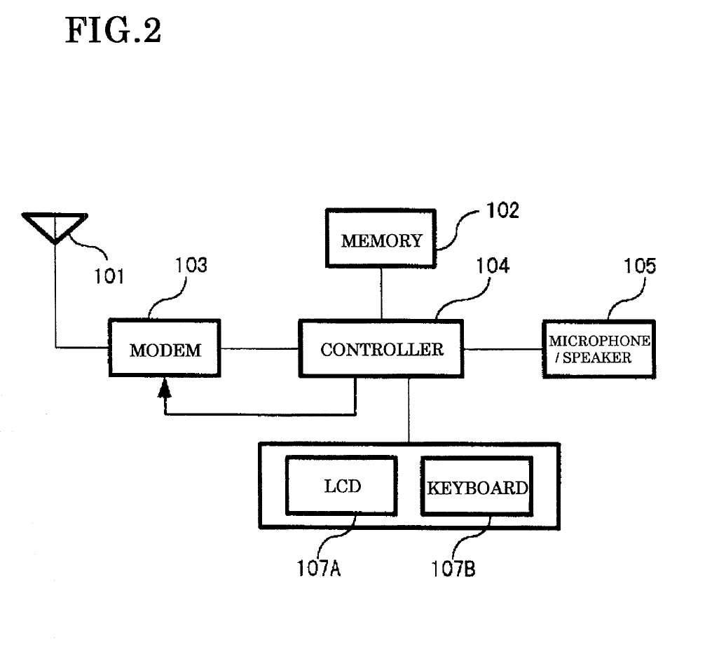

FIG. 2 is a block diagram of a cellular phone in accordance with the first embodiment of the present invention.

The cellular phone is comprised of an antenna 101 through which radio signals are transmitted therefrom to a network and received from a network therethrough, a radio signal modem 103 which modulates radio signals to be transmitted to a network and demodulates radio signals received through a network, a memory 102 storing internal parameters and various data therein, a microphone/speaker 105 through which a user inputs voice instructions to the cellular phone or voice outputs are transmitted to a user, a liquid crystal display unit 107A displaying various data input into the controller 104 by user or received through a network, a keyboard 107B through which a user can input data or instructions into the controller 104, and a controller 104 controlling an operation of the memory 102, the radio signal modem 103, the microphone/speaker 105, the liquid crystal display unit 107A, and the keyboard 107B.

The cellular phone is connected to a personal computer, and downloads first data into the memory 102 from a database equipped in the personal computer which first data indicates sites in which a cellular phone should not be used, such as a hospital, a movie house, a theater or other public spaces.

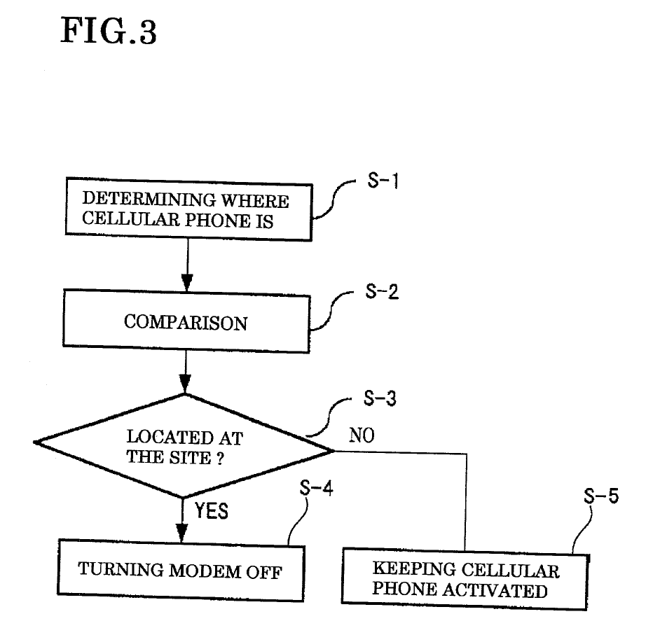

FIG. 3 is a flow chart showing an operation of the cellular phone in accordance with the first embodiment.

Hereinbelow is explained an operation of the cellular phone with reference to FIG. 3.

First, the cellular phone receives a radio signal from a base station (not illustrated) through the antenna 101 and the radio signal modem 103. The controller 104 analyzes the thus received radio signal, and determines where the cellular phone is now, in step S-1.

Then, the controller 104 reads the first data out of the memory 102, and compares the received radio signal to the first data, in step S-2, to thereby judge whether the cellular phone is located at any one of the sites indicated by the first data, in step S-3.

If the controller 104 judges that the cellular phone is located at any one of the sites (YES in step S-3), the controller 104 turns the radio signal modem 103 off, in step S-4.

If the controller 104 judges that the cellular phone is not located at any one of the sites (NO in step S-3), the controller 104 keeps the cellular phone activated, in step S-5.

In accordance with the first embodiment, if the cellular phone is located at any one of predetermined sites, the controller 104 turns only the radio signal modem 103 off Hence, it is not necessary for a user to turn the cellular phone off at the predetermined sites, and transfer the cellular phone into a mode where only the liquid crystal display unit 107A and the keyboard 107B are in operation for writing a mail or editing a telephone directory.

Thus, even if a user forgets turning his/her cellular phone off at the predetermined sites, it is possible to avoid a bell from ringing to inform a user of receipt of a call.

In the above-mentioned first embodiment, the radio signal modem 103 is turned off, if the cellular phone is located at any one of the predetermined sites. The controller 104 may turn a power source of the cellular phone off instead of turning the radio signal modem 103 off.

Hereinbelow is explained a cellular phone in accordance with the second embodiment.

The cellular phone in accordance with the second embodiment has the same structure as the structure of the cellular phone in accordance with the first embodiment, illustrated in FIG. 2, but operates in a different manner from the first embodiment.

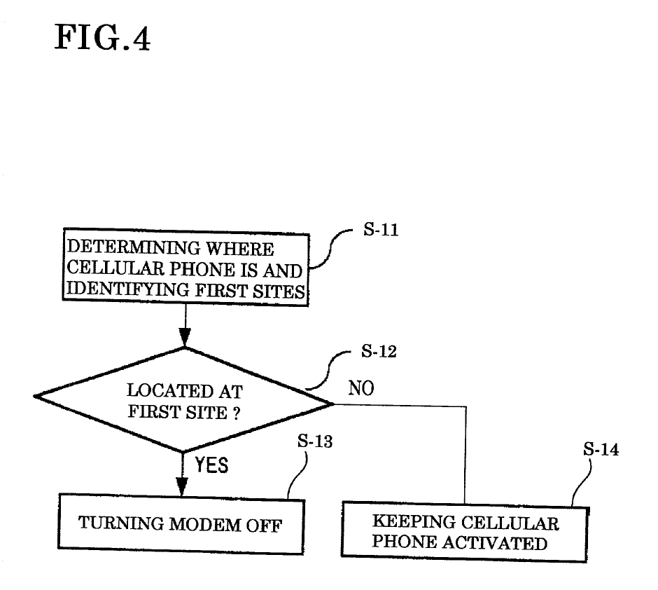

FIG. 4 is a flow chart showing an operation of the cellular phone in accordance with the second embodiment.

Hereinbelow is explained an operation of the cellular phone in accordance with the second embodiment, with reference to FIG. 4.

First, the cellular phone receives a radio signal from a base station (not illustrated) through the antenna 101 and the radio signal modem 103. The controller 104 analyzes the thus received radio signal, and determines where the cellular phone is now, and identifies first sites located within a service area covered by the base station, in step S-11.

Herein, the first sites indicate sites where a cellular phone should not be used, such as a hospital, a movie house, a theater or other public spaces.

Then, the controller 104 judges whether the cellular phone is located at any one of the first sites, in step S-12.

If the controller 104 judges that the cellular phone is located at any one of the first sites (YES in step S-12), the controller 104 turns the radio signal modem 103 off, in step S-13.

If the controller 104 judges that the cellular phone is not located at any one of the first sites (NO in step S-12), the controller 104 keeps the cellular phone activated, in step S-14.

Hereinbelow is explained a cellular phone in accordance with the third embodiment.

The cellular phone in accordance with the third embodiment has the same structure as the structure of the cellular phone in accordance with the first embodiment, illustrated in FIG. 2, but operates in a different manner from the first embodiment.

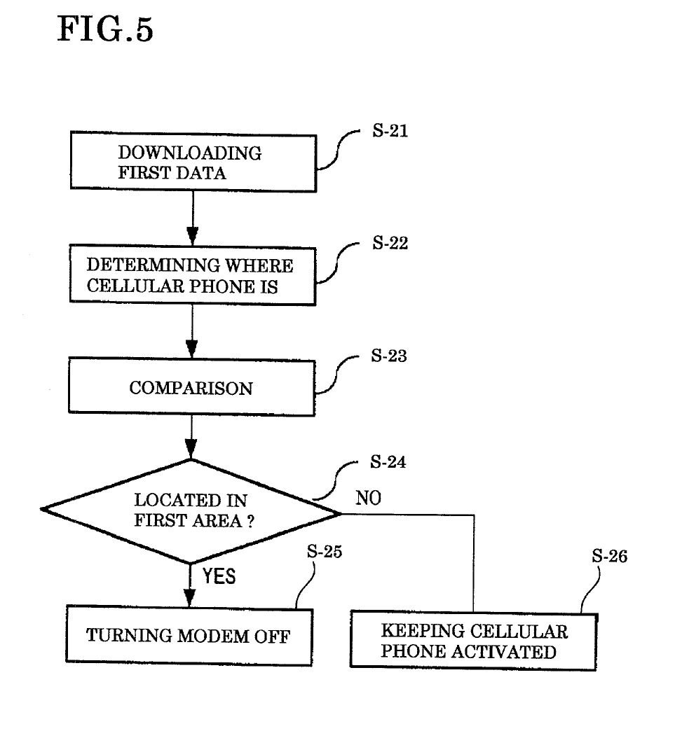

FIG. 5 is a flow chart showing an operation of the cellular phone in accordance with the third embodiment.

Hereinbelow is explained an operation of the cellular phone in accordance with the third embodiment, with reference to FIG. 5.

First, the cellular phone is connected to a personal computer, and downloads first data into the memory 102 from a database equipped in the personal computer, in step S-21. The first data indicates first areas each of which contains a predetermined site. Herein, the predetermined site indicates a site in which a cellular phone should not be used, such as a hospital, a movie house, a theater or other public spaces. In the third embodiment, each of the first areas is defined as a circular area having a radius of 50 m and centrally including the predetermined site.

Then, the cellular phone receives a radio signal from a base station (not illustrated) through the antenna 101 and the radio signal modem 103. The controller 104 analyzes the thus received radio signal, and determines where the cellular phone is now, in step S-22.

Then, the controller 104 reads the first data out of the memory 102, and compares the received radio signal to the first data, in step S-23, to thereby judge whether the cellular phone is located in one of the first areas indicated by the first data, in step S-24.

If the controller 104 judges that the cellular phone is located in any one of the first areas (YES in step S-24), the controller 104 turns the radio signal modem 103 off, in step S-25.

If the controller 104 judges that the cellular phone is not located in any one of the first areas (NO in step S-24), the controller 104 keeps the cellular phone activated, in step S-26.

Hereinbelow is explained a cellular phone in accordance with the fourth embodiment.

The cellular phone in accordance with the fourth embodiment has the same structure as the structure of the cellular phone in accordance with the first embodiment, illustrated in FIG. 2, but operates in a different manner from the first embodiment.

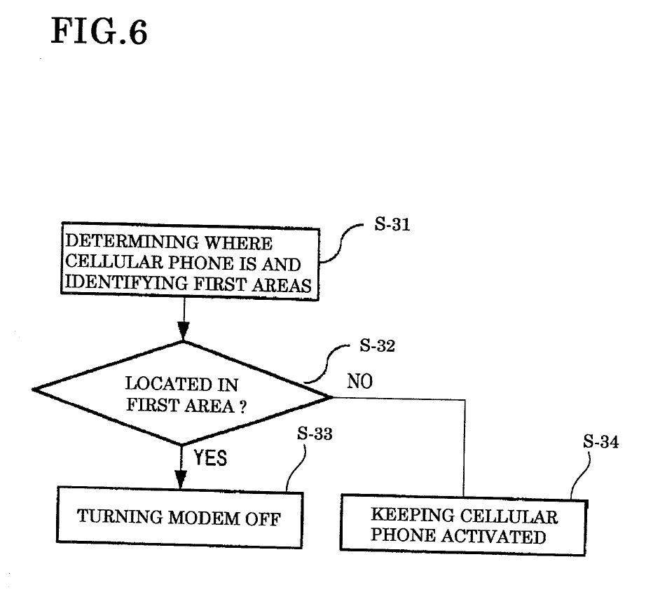

FIG. 6 is a flow chart showing an operation of the cellular phone in accordance with the fourth embodiment.

Hereinbelow is explained an operation of the cellular phone in accordance with the fourth embodiment, with reference to FIG. 6.

First, the cellular phone receives a radio signal from a base station (not illustrated) through the antenna 101 and the radio signal modem 103. The controller 104 analyzes the thus received radio signal, and determines where the cellular phone is now, and identifies first areas located within a service area covered by the base station, in step S-31.

Herein, each of the first areas contains a predetermined site. Herein, the predetermined site indicates a site in which a cellular phone should not be used, such as a hospital, a movie house, a theater or other public spaces. In the fourth embodiment, each of the first areas is defined as a circular area having a radius of 30 m and centrally including the predetermined site.

Then, the controller 104 judges whether the cellular phone is located in any one of the first areas, in step S-32.

If the controller 104 judges that the cellular phone is located in any one of the first areas (YES in step S-32), the controller 104 turns the radio signal modem 103 off, in step S-33.

If the controller 104 judges that the cellular phone is not located in any one of the first areas (NO in step S-32), the controller 104 keeps the cellular phone activated, in step S-34.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-342393 filed on Nov. 9, 2000 including specification, claims, drawings and summary is incorporated herein by reference in its entirety.

What is claimed is:

1. A cellular phone comprising:
(a) a memory storing first data indicative of predetermined sites; and
(b) a controller which receives second data from a base station which second data indicates where said cellular phone is, compares the thus received second data to said first data, and stops an operation of said cellular phone, if said cellular phone is located at said predetermined sites indicated by said first data.

2. The cellular phone as set forth in claim 1, wherein said predetermined sites are sites in which it is unpreferable to make a call through a cellular phone.

3. The cellular phone as set forth in claim 1, wherein said controller downloads said first data into said memory from an external database.

4. The cellular phone as set forth in claim 1, further comprising a modem which modulates signals to be transmitted from said cellular phone and demodulates signals received, and wherein said controller stops an operation of said modem, if said cellular phone is located at said predetermined sites indicated by said first data.

5. A cellular phone comprising:
a controller which receives from a base station both first data which indicates where said cellular phone is, and second data which indicates a first site within a service area covered by said base station, compares the thus received first data to said second data, and stops an operation of said cellular phone, if said cellular phone is located at said first site.

6. The cellular phone as set forth in claim 5, wherein said first site is a site in which it is unpreferable to make a call through a cellular phone.

7. The cellular phone as set forth in claim 5, wherein said controller downloads said second data thereinto from an external database.

8. The cellular phone as set forth in claim 5, further comprising a modem which modulates signals to be transmitted from said cellular phone and demodulates signals received, and wherein said controller stops an operation of said modem, if said cellular phone is located at said predetermined sites indicated by said first data.

9. A cellular phone comprising:
(a) a memory storing first data indicative of a first area in which predetermined sites are; and
(b) a controller which receives from a base station second data which indicates where said cellular phone is, compares the thus received second data to said first data, and stops an operation of said cellular phone, if said cellular phone is located in said first area.

10. The cellular phone as set forth in claim 9, wherein said predetermined sites are sites in which it is unpreferable to make a call through a cellular phone.

11. The cellular phone as set forth in claim 9, wherein said controller downloads said first data into said memory from an external database.

12. The cellular phone as set forth in claim 9, further comprising a modem which modulates signals to be transmitted from said cellular phone and demodulates signals received, and wherein said controller stops an operation of said modem, if said cellular phone is located at said predetermined sites indicated by said first data.

13. A cellular phone comprising:
a controller which receives from a base station both first data which indicates where said cellular phone is, and second data which indicates a first area within a service area covered by said base station, compares the thus received first data to said second data, and stops an operation of said cellular phone, if said cellular phone is located in said first area.

14. The cellular phone as set forth in claim 13, wherein said first area is an area in which it is unpreferable to make a call through a cellular phone.

15. The cellular phone as set forth in claim 13, wherein said controller downloads said second data thereinto from an external database.

16. The cellular phone as set forth in claim 13, further comprising a modem which modulates signals to be transmitted from said cellular phone and demodulates signals received, and wherein said controller stops an operation of said modem, if said cellular phone is located at said predetermined sites indicated by said first data.

17. A method of operating a cellular phone, comprising the steps of:
(a) storing first data indicative of predetermined sites;
(b) receiving second data from a base station which second data indicates where said cellular phone is;
(c) comparing said second data to said first data; and
(d) stopping an operation of said cellular phone, if said cellular phone is located at said predetermined sites.

18. The method as set forth in claim 17, further comprising the step of downloading said first data from an external database.

19. The method as set forth in claim 17, wherein an operation of a modem of said cellular phone is stopped in said step (d).

20. A method of operating a cellular phone, comprising the steps of:
(a) receiving from a base station both first data which indicates where said cellular phone is, and second data which indicates a first site within a service area covered by a base station;
(b) comparing said first data to said second data; and
(c) stopping an operation of said cellular phone, if said cellular phone is located at said first site.

21. The method as set forth in claim 20, further comprising the step of downloading said first data from an external database.

22. The method as set forth in claim 20, wherein an operation of a modem of said cellular phone is stopped in said step (c).

23. A method of operating a cellular phone, comprising the steps of:
(a) storing first data indicative of a first area in which predetermined sites are;
(b) receiving from a base station second data which indicates where said cellular phone is;
(c) comparing said second data to said first data; and
(d) stopping an operation of said cellular phone, if said cellular phone is located in said first area.

24. The method as set forth in claim 23, further comprising the step of downloading said first data from an external database.

25. The method as set forth in claim 23, wherein an operation of a modem of said cellular phone is stopped in said step (d).

26. A method of operating a cellular phone, comprising the steps of:
(a) receiving from a base station both first data which indicates where said cellular phone is, and second data which indicates a first area within a service area covered by said base station;
(b) comparing said first data to said second data; and
(c) stopping an operation of said cellular phone, if said cellular phone is located in said first area.

27. The method as set forth in claim 26, further comprising the step of downloading said first data from an external database.

28. The method as set forth in claim 26, wherein an operation of a modem of said cellular phone is stopped in said step (c).
